(19) United States
(12) Patent Application Publication
(10) Pub. No.: US 2026/0268884 A1
(43) Pub. Date: Sep. 10, 2026

(54) VOICE PROCESSING METHOD, APPARATUS, AND ELECTRONIC DEVICE

(71) Applicant: Beijing Zitiao Network Technology Co., Ltd., Haidian District, Beijing (CN)

(72) Inventors: Chang XIAO, Beijing (CN); Ye MA, Beijing (CN); Jin HUANG, Beijing (CN); Jing LI, Beijing (CN)

(21) Appl. No.: 19/133,357

(22) PCT Filed: Nov. 9, 2023
(86) PCT No.: PCT/CN2023/130761

§ 371 Date: May 28, 2025

(30) Foreign Application Priority Data
Dec. 21, 2022 (CN) 202211648341.0

(51) Int. Cl. G10K 11/178; G06F 3/04842; G10L 21/0208

(52) U.S. Cl. CPC G10K 11/17854; G06F 3/04842; G10L 21/0208; G10L 2021/02082

(57) ABSTRACT

A voice processing method and apparatus, and an electronic device. The method includes: receiving a remote voice frame; determining, based on a voice spectrum estimation result of the remote voice frame and a noise spectrum estimation result of a noise frame corresponding to an ambient noise scene, a filter coefficient of a filter; filtering the remote voice frame using the filter having the filter coefficient to obtain a filtered voice frame; determining, based on a plurality of output voice frames cached in the terminal device, the remote voice frame, and a preset loudness corresponding to a current system volume of the terminal device, an expected loudness of an output voice frame corresponding to the remote voice frame; and determining, based on the expected loudness and the filtered voice frame, an output voice frame corresponding to the remote voice frame.

### CROSS-REFERENCE TO RELATED APPLICATION(S)

The present disclosure claims the priority from the CN patent application No. 202211648341.0 entitled “Voice processing method, apparatus, and electronic device” filed with the China National Intellectual Property Administration (CNIPA) on Dec. 21, 2022, the contents of which are hereby incorporated by reference in their entirety.

### FIELD

The present disclosure relates to the voice processing field, in particular, to a voice processing method, an apparatus, and an electronic device.

### BACKGROUND

Due to the wide application of the mobile terminal in daily life, voice communication with a remote party via a mobile terminal has become a common scene. In a noisy environment, users are inevitably disturbed by the environmental noise. The Active Noise Control (ANC) technology is an effective noise cancellation solution. However, the existing ANC technology typically includes acquiring ambient noise in real time to improve the near-field intelligibility of the remote voice by analyzing and suppressing ambient noise. This costs lots of computer resources of the mobile terminal.

In the case, how to minimize the computing resources consumed for noise cancellation while keeping the near-field intelligibility of the remote voice not lower than a preset threshold is an urgent technical problem to be solved.

### SUMMARY

The embodiments of the present disclosure provide a voice processing method, which can minimize the computing resources of the mobile terminal when the near-field intelligibility of the remote voice is lower than a certain predetermined threshold, while reducing greatly the computing resources of the mobile terminal during noise cancellation.

The embodiments of the present disclosure further provide a voice processing apparatus, an electronic device, and a computer readable storage medium.

In the embodiments of the present disclosure, the following technical solution is employed:

In a first aspect, there is provided a voice processing method, which is applied to a terminal device, including:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively; and
determining, based on the expected loudness and the filtered voice frame, an output voice frame corresponding to the remote voice frame.

In a second aspect, there is provided a voice processing apparatus, comprising:
a receiving module for receiving a remote voice frame;
a first determining module for determining, based on a voice spectrum estimation result of the remote voice frame and a noise spectrum estimation result of a noise frame corresponding to an ambient noise scene, a filter coefficient of a filter;
a filter module for filtering the remote voice frame using the filter having the filter coefficient to obtain a filtered voice frame;
a second determining module for determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively; and
a third determining module for determining, based on the expected loudness and the filtered voice frame, the output voice frame corresponding to the remote voice frame.

In a third aspect, there is provided an electronic device, including:
a processor; and
a memory for storing computer executable instructions that cause, when executed, the processor to perform the following operations:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively; and
determining, based on the expected loudness and the filtered voice frame, an output voice frame corresponding to the remote voice frame.

In a fourth aspect, there is provided a computer readable storage medium having one or more executable instructions stored thereon, wherein the executable instructions, when executed by a processor, implement the following operations:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively; and
determining, based on the expected loudness and the filtered voice frame, an output voice frame corresponding to the remote voice frame.

The at least one technical solution employed in the embodiments of the present disclosure can achieve the following advantageous effects:
by determining, based on a voice spectrum estimation result of the remote voice frame and a noise spectrum estimation result of a noise frame corresponding to an ambient noise scene, a filter coefficient of a filter, performing filtering using the filter having the filter coefficient, and adjusting an output loudness based on an output voice frame cached in the terminal device to obtain the output voice frame, the technical solution can minimize the computing resources of the mobile terminal as much as possible when the near-field intelligibility of the remote voice is lower than a certain predetermined threshold, while reducing greatly the computing resources of the mobile terminal during noise cancellation.

### BRIEF DESCRIPTION OF THE DRAWINGS

Drawings described herein are provided for further understanding of the present disclosure, which form a part of the present disclosure. The example embodiments of the present disclosure and the description thereon are intended to explain the present disclosure and do not formulate any improper limitation thereto. In the drawings:

FIG. 1 illustrates a flowchart of a voice processing method according to embodiments of the present disclosure.

FIG. 2 illustrates a flowchart of determining a filter coefficient according to embodiments of the present disclosure.

FIG. 3 illustrates a flowchart of a method for compressing voice in real time within a dynamic range according to embodiments of the present disclosure.

FIG. 4 illustrates a schematic diagram of a structure of a voice processing apparatus according to embodiments of the present disclosure.

FIG. 5 illustrates a schematic diagram of an example electronic device according to the present disclosure.

### DETAILED DESCRIPTION OF EMBODIMENTS

In order to make the objective, the technical solution and the advantages of the present disclosure more apparent, a clear, complete description on the technical solution of the present disclosure will be provided below in conjunction with the embodiments and the corresponding drawings thereof. Obviously, the embodiments described herein are only a part of the embodiments of the present disclosure, not all of them. All the other embodiments acquired by the ordinary skilled in the art on the basis of the embodiments described herein fall into the protection scope of the present disclosure. For ease of understanding of the embodiments of the present disclosure, the following concepts are introduced:

Sound field: the sound field can be divided into a near field and a far field. The near-field sound beams are concentrated in a cylindrical shape and have an uneven sound intensity distribution. The far-field sound beams are flared in a trumpet shape and have an even sound intensity distribution; however, due to the flared angle of the sound beams, the sound beams become more divergent.

Speech intelligibility: the speech intelligibility, also called Speech Intelligibility Index (SII), is typically measured by a percentage of speech signals transmitted through a certain sound transmission system, which can be understood by a listener. For example, if a listener is given 100 words and hear 50 of them correctly, the speech intelligibility is 50%. In the circumstance where the listener is a constant and the communication system or condition is a variable, different speech intelligibilities of the listener are indices for evaluating the quality of the system or condition.

Near-field intelligibility: the near-field intelligibility refers to a percentage of speech signals transmitted through a sound transmission system, which can be understood by a listener in the near field. For example, in a scenario where a user answers a call with a smartphone, the near-field intelligibility can be used to measure an effect that the user recognizes the speech on the phone.

Human auditory equal loudness contour: the human auditory equal loudness contour refers to a contour of a relationship between a sound pressure level and a frequency of pure tones with the same loudness perceived by typical listeners. The sensitivities of the human ear are varied with sounds of different frequencies. For example, when sounds having the same loudness are played, the human ear is sensitive to the sound around 4,000 Hz, which sounds louder; the human ear is less sensitive to the sound around 8,000 Hz, which sounds smaller. A great number of people are invited to describe a loudness of a sound at each frequency that they heard, and the results are then combined to form a contour which is the human auditory equal loudness contour. The contour was summarized in 1927 and adopted by the International Organization for Standardization in 1933 to form the ISO/R266 standard.

Reference below will be made to the drawings to describe in detail the technical solution provided by the various embodiments of the present disclosure.

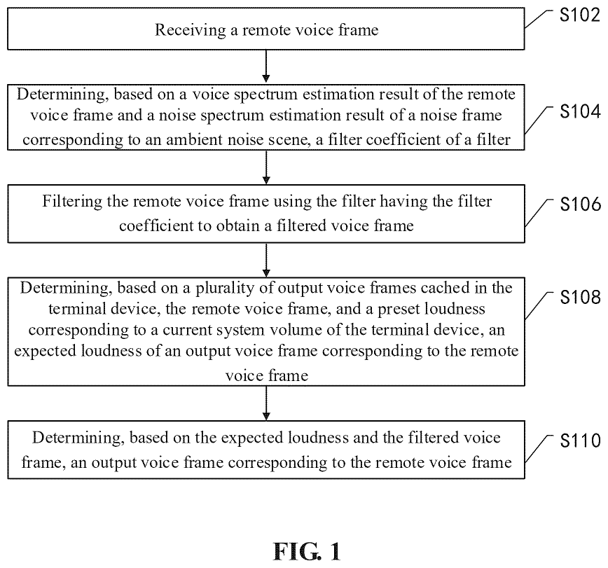

FIG. 1 is a flowchart of a voice processing method according to embodiments of the present disclosure. It would be appreciated that the voice processing method according to the embodiments of the present disclosure can be applied to various types of terminal devices that can receive voices from remote devices such as smart phones, tablets and the like. The method may include:
S102: receiving a remote voice frame.

It would be appreciated that the remote voice frame according to the embodiments of the present disclosure may be a voice frame sent by a remote device that interacts with a local terminal device, or may be a voice frame unilaterally sent by a remote device to a terminal device, which is not restricted to the interaction scenario only. For example, if a terminal device A and a terminal device B are in voice communication with each other, the remote voice frame of the terminal device A is a voice frame sent by the terminal device B to the terminal device A; if the terminal device A sends a voice recording to the terminal device B, the remote voice frame of the terminal device B is a voice frame in the voice recording sent by the terminal device A to the terminal device B. In addition, the remote voice frame according to the embodiments of the present disclosure may be a voice frame only including an audio, or may be a voice frame extracted from a video frame including an image and an audio.
S104: determining, based on a voice spectrum estimation result of the remote voice estimation result and a noise spectrum estimation result of a noise frame corresponding to an ambient noise scene, a filter coefficient of a filter.

It would be appreciated that, in the embodiments of the present disclosure, the voice spectrum estimation result of the remote voice frame may include a spectrum distribution of the remote voice frame. The noise spectrum estimation result of the noise frame may include a spectrum distribution of the noise frame. In the embodiments of the present disclosure, the voice spectrum estimation result or noise spectrum estimation result may be obtained using multiple spectrum estimation methods, which is not limited herein.

There are relatively limited computing resources of the terminal device. However, if the actual ambient noise is acquired in real time, the terminal device needs to consume lots of computing resources. To this end, the embodiments of the present disclosure propose storing an audio clip corresponding to the ambient noise scene in the terminal device prior to determining the filter coefficient, such that the audio clip corresponding to the ambient noise scene can be directly read from the terminal device when determining the filter coefficient, without collecting an external audio in real time through the microphone device of the terminal device.

Optionally, in an embodiment, the ambient noise scene may be configured by the terminal device by default. At this time, the audio clip corresponding to the default ambient noise scene can be used directly to obtain the noise spectrum estimation result of the noise frame.

Optionally, in a further embodiment, the terminal device has stored therein audio clips corresponding to a plurality of candidate ambient noise scenes respectively. In the case, prior to determining the filter coefficient, the user of the terminal device may select a candidate ambient noise scene as the ambient noise scene for determining the filter coefficient. Specifically, before step S104, the method may include:
displaying a selection interface including a plurality of candidate ambient noise scenes, one of the candidate ambient noise scenes corresponding to a pre-stored noise audio clip; and
determining a selected candidate ambient noise scene as the ambient noise scene.

It would be appreciated that, prior to displaying the selection interface including a plurality of candidate ambient noise scenes, the action of displaying the selection interface may be triggered by receiving a scene selecting operation performed by a user of the terminal device.

Optionally, when the terminal device determines presence of a plurality of candidate ambient noise scenes but absence of a default ambient noise scene, the selection interface can be displayed directly.

Optionally, in a still further embodiment, if there is no scene matching the current actual ambient noise scene in the terminal device, the scene can be recorded directly on site and stored as the ambient noise scene for determining the filter coefficient. Specifically, prior to step S104, the method may include:
receiving a scene recording operation performed by a user of the terminal device;
recording an audio of an environment where the terminal device is currently located, using an audio acquisition device of the terminal device; and
creating, based on the recorded audio, a new scene, and using the same as the ambient noise scene.

In the embodiments of the present disclosure, the filter coefficient is determined using an audio clip corresponding to the ambient noise scene stored in the terminal device, to perform filtering, which can reduce greatly computing resources required for acquiring ambient noise scene in real time.

It would be appreciated that the audio clip corresponding to the ambient noise scene contains a plurality of frames, and a noise frame corresponding to the ambient noise scene where the remote voice frame is located can be determined using multiple methods, so as to obtain a noise spectrum estimation result of the noise frame.

Optionally, the noise audio clip corresponding to the ambient noise scene can be processed in a loop and aligned with real-time remote voice frames, which is equivalent to that the noise audio clip corresponding to the ambient noise scene is spliced in a loop to simulate real-time scene noise. If the noise audio clip corresponding to the ambient noise scene contains N frames, a first remote voice frame corresponds to a first frame of the noise audio clip, a second remote voice frame corresponds to a second frame of the noise audio clip . . . , an N^{th} remote voice frame corresponds to an N^{th} frame of the noise audio clip; then, an (N+1)^{th} remote voice frame corresponds to the first frame of the noise audio clip, and so on.

Optionally, assumed that the noise is stable, an average spectrum of noise may be obtained in the time dimension by averaging the obtained time-frequency spectra of the noise audio clip corresponding to the ambient noise scene. At this time, the noise frame is a constant frame, and a noise spectrum estimation result of the noise frame is an average spectrum of noise as mentioned above.

It would be appreciated that, in the two solutions mentioned above, a first solution is generally applied to a noise audio clip with a duration/frame length exceeding a preset duration/frame length, and a second solution is generally applied to a noise audio clip with a duration/frame length less than the preset duration/frame length. For example, the first solution is selected if the duration is greater than 2 seconds, and the second solution is selected if the duration is less than 2 seconds. However, this is not absolute. The second solution may be selected for a noise audio clip with a duration/frame length greater than the preset duration/frame length, and the first solution may be selected for a noise audio clip with a duration/frame length less than the preset duration/frame length. In the embodiments of the present disclosure, after obtaining the remote voice frame and the noise frame of the ambient noise scene, the coefficient of the filter can be determined based on the remote voice frame and the noise frame.

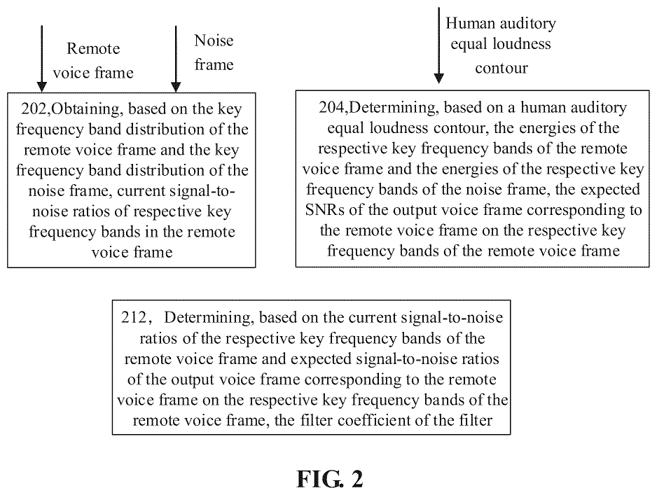

FIG. 2 is a flowchart of determining a filter coefficient according to the embodiments of the present disclosure.

Optionally, in an embodiment, the step S104 shown in FIG. 2 may be instantiated specifically as follows:
202: obtaining, based on the key frequency band distribution of the remote voice frame and the key frequency band distribution of the noise frame, current signal-to-noise ratios of respective key frequency bands in the remote voice frame.

In the embodiment of the present disclosure, the voice spectrum estimation result includes a key frequency band distribution of the remote voice frame, and the noise spectrum estimation result includes a key frequency band distribution of the noise frame.

Due to different spectrum estimation methods, the obtained key frequency band distribution of the remote voice frame or the noise frame are varied. In general, given an upper limit and a lower limit frequency as well as a number of frequency bands, a set of key frequency bands can be obtained. For example, if the Bark spectrogram is employed, the upper and lower limits of the spectrum are set to 20 Hz and 16,000 Hz, respectively; and if the number of the frequency bands is 8, 8 frequency band centers [175.27, 526.8, 1008.95, 1741.27, 2905.36, 4789.86, 7862.05, 12883.7], namely filter bank bands in the Bark spectrogram, can be obtained. To the human, the eight frequency bands sound to cover substantially the same pitch range. For example, to the human, [20-330.54 Hz] and [330.54-723.06 Hz] cover roughly the same pitch range. These are the first two key frequency bands of the Bark spectrogram, respectively centered at 175.27 Hz and 526.8 Hz. It would be appreciated that selecting the voice spectrum estimation result of the remote voice frame and the noise spectrum estimation result of the noise frame may include selecting other filter bank bands, for example, filter bank bands in the Mel spectrogram and the like, except the filter bank bands in the Bark spectrogram, which is not specifically limited in the embodiment of the present disclosure.

Specifically, step 202 may include:
determining energy corresponding to the respective frequency bands in the remote voice frame, based on the key frequency band distribution of the remote voice frame;
determining energy corresponding to the respective key frequency bands in the noise frame, based on the key frequency band distribution of the noise frame; and
determining, based on the energy corresponding to the respective key frequency bands of the remote voice frame and the energy corresponding to the respective key frequency bands of the noise frame, the current signal-to-noise ratios of the respective key frequency bands of the remote voice frame.

For example, based on the distribution of the 8 key frequency bands of the remote voice frame in the Bark spectrogram, energies P_{y1}, P_{y2} . . . P_{y8} of the remote voice frame on the 8 key frequency bands in can be obtained. Based on the distribution of the 8 key frequency bands of the noise frame in the Bark spectrogram, energies P_{z1}, P_{z2} . . . P_{z8} of the noise frame on the 8 key frequency bands can be obtained. Subsequently, based on the energies P_{y1}, P_{y2} . . . P_{y8} and energies P_{z1}, P_{z2} . . . P_{z8}, current signal-to-noise ratios P_{y1}/P_{z1}, P_{y2}/P_{z2} . . . P_{y8}/P_{z8} of the remote voice frame on the 8 key frequency bands can be obtained. The method for determining the signal-to-noise ratios, as listed herein, is provided only for reference. See the prior art for the specific computing method.
212: determining based on the current signal-to-noise ratios of the respective key frequency bands in the remote voice frame, and expected signal-to-noise ratios of an output voice frame corresponding to the remote voice frame on the respective key frequency bands of the remote voice frame, the filter coefficient of the filter,.

After obtaining the actual SNRs of the respective key frequency bands of the remote voice frame, and expected SNRs of the output voice frame corresponding to the remote voice frame on the respective key frequency bands of the remote voice frame, the filter coefficient of the filter can be determined based on the obtained actual SNRs and expected SNRs, so as to obtain the output voice frame matching the expected SNRs on the respective key frequency bands by filtering the remote voice frame.

It would be appreciated that, prior to step 212, the method may further include step 204:
204: determining, based on a human auditory equal loudness contour, the energies of the respective key frequency bands of the remote voice frame and the energies of the respective key frequency bands of the noise frame, the expected SNRs of the output voice frame corresponding to the remote voice frame on the respective key frequency bands of the remote voice frame.

Specifically, step 204 may further include:
determining human average loudness perception correction factors corresponding to the respective key frequency bands of the remote voice frame, based on loudness of the remote voice frame and the noise frame on the respective key frequency bands of the remote voice frame, and the human auditory equal loudness contour corresponding to the current system volume of the terminal device; and
determining, based on the human average loudness perception correction factors corresponding to the respective key frequency bands of the remote voice frame and preset reference signal-to-noise ratios to obtain the expected signal-to-noise ratios of the output voice frame corresponding to the remote voice frame on the respective key frequency bands of the remote voice frame, respective corrected signal-to-noise ratios of the respective key frequency bands of the remote voice frame,
wherein reference signal-to-noise ratios of the respective key frequency bands of the remote voice frame are identical, and a human average loudness perception correction factor of a target key frequency band in the respective key frequency bands of the remote voice frame is used for correcting a loudness of the target key frequency band, to adjust a signal-to-noise ratio of the target key frequency band, such that the loudness perceived by the human over the respective key frequency bands can be kept consistent.

Optionally, the step of determining the human average loudness perception correction factors may specifically include:
determining, based on the loudness of the remote voice frame and the noise frame on the respective key frequency bands of the remote voice frame and the human auditory equal loudness contour corresponding to the current system volume of the terminal device, actually perceived loudness and an average actually perceived loudness of the respective key frequency bands of the remote voice frame; and
determining, based on the actually perceived loudness and the average actually perceived loudness of the respective key frequency bands of the remote voice frame, the respective human average loudness perception correction factors of the plurality of key frequency bands of the remote voice frame.

In addition, the same reference SNR selected for the plurality of key frequency bands of the remote voice frame may be dependent on an enhanced expectation. For example, 10 dB, 5 dB, or the like, may be selected.

Hereinafter, in conjunction with a specific equation, description will be made on how to compute the expected SNRs of the output voice frame corresponding to the remote voice frame on the respective key frequency bands. A human average loudness correction factor of the kth key frequency band is recorded as N[k].

First of all, the actually perceived loudness P[k] of the k^{th} key frequency band may be computed based on the loudness of the remote voice frame and the noise frame on the current kth key frequency band, and the human auditory equal loudness contour corresponding to the current system volume.

Second, the average actually perceived loudness M of all the key frequency bands can be obtained after acquiring the actually perceived loudness of all the key frequency bands.

Third, N[k]=w[k]*(M−P[k]) can be computed, where w[k] is a coefficient for adjusting each specific frequency band weight which is typically valued around 1.0.

Finally, for the k^{th} key frequency band, the expected SNR thereof may be represented as the reference SNR+N[k].

In the embodiment of the present disclosure, by introducing the human auditory equal loudness contour, the difference of loudness at different frequencies perceived by the human is taken into account, and as a result, the enhanced audio sounds clearer to the human than the audio with a randomly selected SNR.
S106: filtering the remote voice frame using the filter having the filter coefficient to obtain a filtered voice frame.

After determining the filter coefficient, the remote voice frame is filtered. See the prior art for the specific implementation.
S108: determining, based on a plurality of output voice frames cached in the terminal device, the remote voice frame, and a preset loudness corresponding to a current system volume of the terminal device, an expected loudness of an output voice frame corresponding to the remote voice frame.

Wherein, the plurality of output voice frames cached in the terminal device includes output voice frames corresponding to a plurality of received voice frames close to the remote voice frame in time sequence respectively.

The remote voice frame is a voice frame currently received, and a plurality of received voice frames close to the distal voice frames in time sequence are received voice frames preceding the current voice frame. For example, assumed that the remote voice frame is the P^{th} received voice frame, N received voice frames close to the remote voice frames in time sequence include a (P−1)^{th} frame, a (P−2)^{th} frame . . . and a (P−N)^{th} frame, and the output voice frames cached in the terminal device include an output voice frame corresponding to the (P−1)^{th} received voice frame, an output voice frame corresponding to the (P−2)^{th} received voice frame . . . and an output voice frame corresponding to the (P−N)^{th} received voice frame.

In the embodiments of the present disclosure, as a uniform loudness is employed, the audio can be compressed in real time within a dynamic range while it is guaranteed that no sudden change occurs to the loudness.
S110: determining, based on the expected loudness and the filtered voice frame, an output voice frame corresponding to the remote voice frame.

The embodiments of the present disclosure include: determining, based on a voice spectrum estimation result of the remote voice frame and a noise spectrum estimation result of a noise frame corresponding to an ambient noise scene, a filter coefficient of a filter; performing filtering using the filter having the filter coefficient; and adjusting an output loudness based on an output voice frame cached in the terminal device to obtain the output voice frame. Since there is no need for turning on the microphone during the course, the computing resources of the mobile terminal can be minimized when the near-field intelligibility of the remote voice is lower than a certain predetermined threshold, and the computing resources of the mobile terminal can be greatly reduced during noise cancellation.

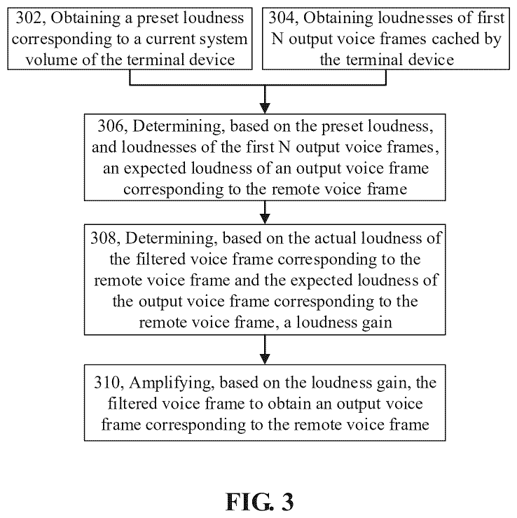

FIG. 3 is flowchart of a method for compressing voice in real time within a dynamic range according to embodiments of the present disclosure. The specific implementations of step S108 and step S110 are shown in FIG. 3, where step S108 may include 302, 304 and 306, and step S110 may include 308 and 310.
302: obtaining a preset loudness corresponding to a current system volume of the terminal device.
304: obtaining loudness of first N output voice frames cached by the terminal device.
306: determining an expected loudness of an output voice frame corresponding to the distal voice frame, based on the preset loudness, and loudness of the first N output voice frames.

It is assumed that: the preset loudness corresponding to the current system volume of the terminal device is S₀, the loudness of the first N output voice frames are respectively S₁ through S_{N}, and the expected loudness of the output voice frame corresponding to the distal voice frame is S. Then, S=(N+1)S₀−(S₁+ . . . +S_{N}).
S308: determining, based on the actual loudness of the filtered voice frame corresponding to the remote voice frame, and the expected loudness of the output voice frame corresponding to the remote voice frame, a loudness gain.

Assumed that the actual loudness of the filtered voice frame is S_{z}, the loudness gain may be expressed as S/S_{z}.
310: amplifying, based on the loudness gain, the filtered voice frame to obtain an output voice frame corresponding to the remote voice frame.

In the embodiments of the present disclosure, the loudness is unified using the method for compressing voice in real time within a dynamic range, such that the remote audio can be compressed in real time within a dynamic range while it is guaranteed that no sudden change occurs to the loudness.

After the method of generating the output voice frame is performed, it is further required to store the output voice frame in the cache of the terminal device according to a First-In First-Out strategy, such that loudness of output voice frames corresponding to respective remote voice frames can be unified when receiving the remote voice frames, to thus avoid a sudden change in the output voice frames.

It is worth noting that performers of respective steps of the methods provided in the respective method flowcharts of the present disclosure may be the same device, or the methods may be performed by different devices as the performers. For example, the performer of steps 21 and 22 may be a device 1, and the performer of step 23 may be a device 2; for another example, the performer of step 21 may be a device 1, and the performer of steps 22 and 23 may be a device 2, and the like.

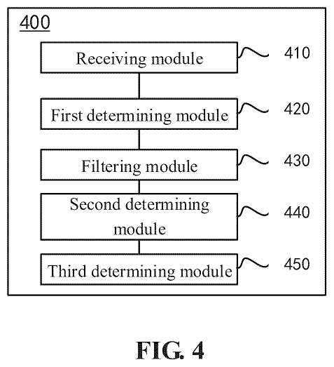

FIG. 4 is a schematic diagram of a structure of a voice processing apparatus 400 according to embodiments of the present disclosure. As shown therein, the apparatus 400 includes:
a receiving module 410 for receiving a remote voice frame;
a first determining module 420 for determining, based on a voice spectrum estimation result of the remote voice frame and a noise spectrum estimation result of a noise frame corresponding to an ambient noise scene, a filter coefficient of a filter;
a filter module 430 for filtering the remote voice frame using the filter having the filter coefficient to obtain a filtered voice frame;
a second determining module 440 for determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively; and
a third determining module 450 for determining, based on the expected loudness and the filtered voice frame, the output voice frame corresponding to the remote voice frame.

It would be appreciated that the terminal device mentioned herein is a terminal device deployed with the apparatus 400.

In the embodiments of the present disclosure, the apparatus 400 can determine a filter coefficient of a filter, based on a voice spectrum estimation result of the remote voice frame and a noise spectrum estimation result of a noise frame corresponding to an ambient noise scene; performing filtering using the filter having the filter coefficient, and can adjust an output loudness based on an output voice frame cached in the terminal device to obtain the output voice frame. Since there is no need for turning on the microphone during the course, the computing resources of the mobile terminal can be minimized when the near-field intelligibility of the remote voice is lower than a certain predetermined threshold, and the computing resources of the mobile terminal can be greatly reduced during noise cancellation.

Optionally, the first determining module 420 is specifically used to:
obtain current signal-to-noise ratios of respective key frequency bands in the remote voice frame, based on the key frequency band distribution of the remote voice frame and the key frequency band distribution of the noise frame; and
determine the filter coefficient of the filter, based on the current signal-to-noise ratios of the respective key frequency bands in the remote voice frame, and expected signal-to-noise ratios of the output voice frame corresponding to the remote voice frame on the respective key frequency bands of the remote voice frame.

Optionally, the apparatus 400 may further include:
a fourth determining module for determining, based on a human auditory equal loudness contour, the energies of the respective key frequency bands of the remote voice frame and the energies of the respective key frequency bands of the noise frame, the expected signal-to-noise ratios of the output voice frame corresponding to the remote voice frame on the respective key frequency bands of the remote voice frame.

Furthermore, the fourth determining module is specifically used to:
determine human average loudness perception correction factors corresponding to the respective key frequency bands of the remote voice frame, based on loudness of the remote voice frame and the noise frame on the respective key frequency bands of the remote voice frame, and the human auditory equal loudness contour corresponding to the current system volume of the terminal device, wherein a human average loudness perception correction factor of a target key frequency band in the respective key frequency bands of the remote voice frame is used for correcting a loudness of the target key frequency band, to adjust a signal-to-noise ratio of the target key frequency band; and
determine, based on the human average loudness perception correction factors corresponding to the respective key frequency bands of the remote voice frame and preset reference signal-to-noise ratios to obtain the expected signal-to-noise ratios of the output voice frame corresponding to the remote voice frame on the respective key frequency bands of the remote voice frame, respective corrected signal-to-noise ratios of the respective key frequency bands of the remote voice frame, wherein reference signal-to-noise ratios of the respective key frequency bands of the remote voice frame are identical.

Optionally, the ambient noise scene is configured by default.

Optionally, the apparatus 400 may further include:
a display module for displaying a selection interface comprising a plurality of candidate ambient noise scenes, one of the candidate ambient noise scenes corresponding to a pre-stored noise audio clip; and
a fifth determining module for determining a selected candidate ambient noise scene as the ambient noise scene.

Optionally, the apparatus 400 may further include:
a second receiving module for receiving a scene recording operation performed by a user of the terminal device;
a recording module for recording an audio of an environment where the terminal device is currently located, using an audio acquisition device of the terminal device; and
a scene storage module for creating, based on the recorded audio, a new scene, and using the same as the ambient noise scene.

Optionally, the second determining module 440 is specifically used to:
obtain the preset loudness corresponding to the current system volume of the terminal device;
obtain loudness of the plurality of output voice frames cached in the terminal device; and
determine, based on the loudness of the plurality of output voice frames cached in the terminal device and the preset loudness corresponding to the current system volume of the terminal device, the expected loudness of the output voice frame corresponding to the remote voice frame, wherein, in response to the loudness of the output voice frame corresponding to the remote loudness frame being valued to the expected loudness, an average loudness of the output voice frame corresponding to the remote voice frame and the plurality of voice frames cached in the terminal device is equal to the preset loudness corresponding to the current system volume of the terminal device.

Optionally, the apparatus 400 may further include a cache module for storing, according to a First-In First-Out strategy, the output voice frame corresponding to the remote voice frame in a cache of the terminal device.

The apparatus 400 can perform the method according to the embodiments depicted in FIGS. 1-3, and implement the functions corresponding to the method steps according to the embodiments shown in FIGS. 1-3. See the embodiments shown in FIGS. 1-3 for details of the implementations.

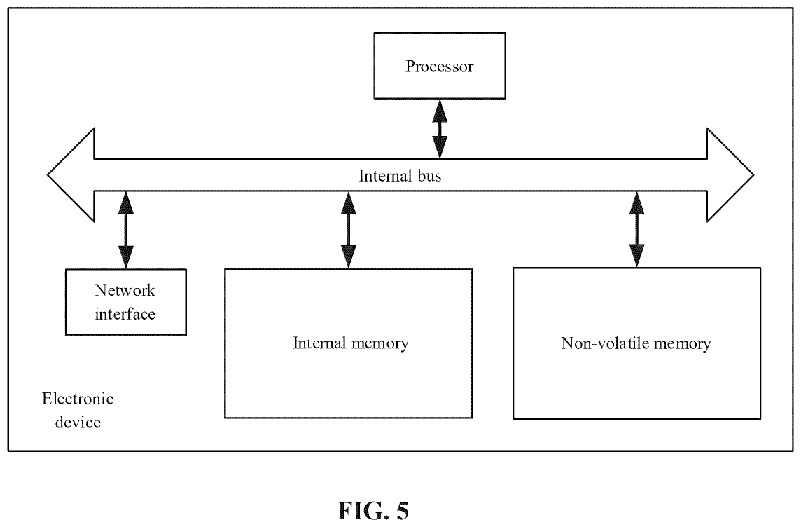

FIG. 5 is a schematic diagram of a structure of an example electronic device according to the present disclosure. Referring to FIG. 5, at the hardware level, the electronic device includes a processor, and optionally includes an internal bus, a network interface, and a memory. Wherein, the memory may include an internal memory such as high-speed Random Access Memory (RAM), and may also include a non-volatile memory such as at least one disk memory, and the like. Of course, the electronic device may also include hardware required by other services.

The processor, the network interface and the memory can be connected to one another through an internal bus which may be an Industry Standard Architecture (ISA) bus, a Peripheral Component Interconnect (PCI) bus, an Extended Industry Standard Architecture (EISA) bus, or the like. The bus may be classified as an address bus, a data bus, a control bus, and the like. For illustration, the bus is represented only by a bidirectional arrow in FIG. 5, which does not indicate that there is only one bus or one type of bus.

The memory is used to store programs. Specifically, the program may include a program code having computer executable instructions. The memory may include an internal memory and a non-volatile memory, and can provide instructions and data to the processor.

The processor reads the corresponding computer program from the non-volatile memory into the internal memory and runs the same, and forms a voice processing apparatus at the logical level. The processor can perform computer executable instructions stored in the memory, and is specifically used to perform the following operations:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively; and
determining, based on the expected loudness and the filtered voice frame, an output voice frame corresponding to the remote voice frame.

The electronic device provided by the embodiments of the present disclosure can determine a filter coefficient of a filter, based on a voice spectrum estimation result of the remote voice frame and a noise spectrum estimation result of a noise frame corresponding to an ambient noise scene; performing filtering using the filter having the filter coefficient, and can adjust an output loudness based on an output voice frame cached in the terminal device to obtain the output voice frame. Since there is no need for turning on the microphone during the course, the computing resources of the mobile terminal can be reduced as much as possible when the near-field intelligibility of the remote voice is lower than a certain predetermined threshold, and the computing resources of the mobile terminal can be greatly decreased during noise cancellation.

The method executed by the voice processing apparatus according to the embodiments shown in FIGS. 1-3, as described above, may be applied to a processor, or may be implemented by a processor. The processor may be an integrated circuit chip having a signal processing capability. In the implementation process, the respective steps of the method can be completed by integrated logic circuitry of hardware in the processor, or instructions in the software form. The processor described above may be a general-purpose processor, including a Central Processing Unit (CPU), a Network Processor (NP), and the like, or may be a Digital Signal Processor (DSP), an Application Specific Integrated Circuit (ASIC), a Field-Programmable Gate Array (FPGA) or other programmable logical device, a discrete gate or transistor logic device, or a discrete hardware component. The respective methods, steps, and logic block diagrams according to the embodiments of the present disclosure may be implemented or performed. The general-purpose processor may be a microprocessor, or the processor may also be any conventional processor, or the like. The steps of the method disclosed in conjunction with the embodiments of the present disclosure may be embodied directly as being executed by a hardware decoding processor, or a combination of hardware and software modules in a decoding processor. The software module can be located in a random memory, a flash memory, a read-only memory, programmable read-only memory or electrically erasable programmable memory, a register, and other storage medium well established in the art. The storage medium is located in the memory, and the processor can read the information in the memory and complete the steps of the above-mentioned method in combination with hardware thereof.

The electronic device can perform the method shown in FIGS. 1-3, and implement the functions of the voice processing apparatus according to the embodiments shown in FIGS. 1-3. The details of the embodiments of the present disclosure are omitted herein for brevity.

The embodiments of the present disclosure further provide a computer readable storage medium having computer executable instructions stored thereon, where the computer executable instructions, when executed by a portable electronic device including a plurality of applications, can cause the portable electronic device to perform the method according to the embodiments shown in FIGS. 1-3, and are specifically used to perform the following operations:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively; and
determining, based on the expected loudness and the filtered voice frame, an output voice frame corresponding to the remote voice frame.

In addition to the software implementation, the electronic device according to the present disclosure may cover other implementations such as a logic device, a combination of software and hardware, and the like, i.e., the performer of the following processing flow is not limited to respective logic units, which may also be a hardware or logic device.

The above description only relates to particular embodiments of the present disclosure, and other embodiments should also be covered in the scope defined by the appended claims. In some circumstances, the acts or steps as recited in the claims may be performed in an order different than the one described in the embodiments and can still achieve the desired outcome. Further, the processes depicted in the drawings dot no necessarily require that such operations be performed in the particular order shown or in sequential order. In certain implementations, multitasking and parallel processing may be advantageous.

Above described are only optimal embodiments of the present disclosure, without suggesting any limitation to the protection scope of the present disclosure. Within the spirits and principles described herein, any modification, equivalent replacement, improvement, and the like shall fall into the protection scope of the present disclosure.

The system, apparatus, module or unit as described in the above embodiments may be specifically implemented by a computer chip or entity, or may be implemented by a product having a certain function. A typical implementation device is a computer. Specifically, the computer may be, for example, a personal computer, a laptop, a cellular phone, a camera phone, a smartphone, a personal digital assistant, a media player, a navigation device, an email device, a game console, a tablet computer, a wearable device, or a combination of any of these devices.

The computer readable medium according to these embodiments may include permanent or non-permanent, movable or non-movable medium and can implement information storage by means of any method or technology. The information may be a computer readable instruction, a data structure, a program device or other data. The examples of a computer storage medium include, but are not limited to, a Phase-change Random Access Memory (PRAM), a Static Random Access Memory (SRAM), a Dynamic Random Access Memory (DRAM) or other type of Random Access Memory (RAM), a Read-Only Memory (ROM), an Electrically Erasable Programmable Read-Only Memory (EEPROM), a flash memory or other memory technology, a Compact Disk Read-Only Memory (CD-ROM), a Digital Versatile Disc (DVD) or other optical storage, a magnetic cassette tape, a magnetic tape and magnetic disk storage or other magnetic storage device, or any other non-transmission media, which can be used to store information that can be accessed by a computing device. As described herein, the computer readable medium does not include transitory computer readable media such as modulated data signals and carriers.

It is worth noting that the terms “include,” “contain,” or any other variants thereof are intended to cover a non-exclusive inclusion, so a process, a method, a product, or a device having a series of elements also include other elements not listed herein explicitly, or elements inherent to the process, method, product, or device, in addition to those elements. Without further limitations, elements defined by “including a . . . ” does not exclude the existence of additional identical or equivalent elements in the process, method, product, or device having the aforesaid elements.

The embodiments of the present disclosure have been described in a progressive way. For same or similar parts of the embodiments, references may be made to the related description thereof. Each embodiment focuses on a difference from other embodiments. Particularly, a system embodiment is similar to a method embodiment, and therefore has been described briefly. For related parts, references can be made to related descriptions in the method embodiment.

1. A method for processing voice, wherein the method is executed by a terminal device and comprises:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively;
determining, based on the expected loudness and the filtered voice frame, an output voice frame corresponding to the remote voice frame.

2. The method of claim 1, wherein the voice spectrum estimation result comprises a key frequency band distribution of the remote voice frame, the noise spectrum estimation result comprises a key frequency band distribution of the noise frame, and determining, based on the voice spectrum estimation result of the remote voice frame and the noise spectrum estimation result of the noise frame corresponding to the ambient noise scene, the filter coefficient of the filter comprises:
obtaining, based on the key frequency band distribution of the remote voice frame and the key frequency band distribution of the noise frame, current signal-to-noise ratios of respective key frequency bands in the remote voice frame;
determining, based on the current signal-to-noise ratios of the respective key frequency bands of the remote voice frame and expected signal-to-noise ratios of the output voice frame corresponding to the remote voice frame on the respective key frequency bands of the remote voice frame, the filter coefficient of the filter.

3. The method of claim 2, wherein
obtaining, based on the key frequency band distribution of the remote voice frame and the key frequency band distribution of the noise frame, the current signal-to-noise ratios of the respective key frequency bands of the remote voice frame comprises:
determining, based on the key frequency band distribution of the remote voice frame, energies corresponding to the respective frequency bands of the remote voice frame;
determining, based on the key frequency band distribution of the noise frame, energies corresponding to the respective key frequency bands of the noise frame;
determining, based on the energies corresponding to the respective key frequency bands of the remote voice frame and the energies corresponding to the respective key frequency bands of the noise frame, the current signal-to-noise ratios of the respective key frequency bands of the remote voice frame.

4. The method of claim 2, wherein prior to determining, based on the current signal-to-noise ratios of the respective key frequency bands in the spectrum distribution of the remote voice frame and the expected signal-to-noise ratios of the output voice frame corresponding to the remote voice frame on the respective key frequency bands in the spectrum distribution of the remote voice frame, the filter coefficient of the filter, the method further comprises:
determining, based on a human auditory equal loudness contour, the energies of the respective key frequency bands of the remote voice frame, and the energies of the respective key frequency bands of the noise frame, the expected signal-to-noise ratios of the output voice frame corresponding to the remote voice frame on the respective key frequency bands of the remote voice frame.

5. The method of claim 4, wherein determining, based on the human auditory equal loudness contour, the energies of the respective key frequency bands of the remote voice frame, and the energies of the respective key frequency bands of the noise frame, the expected signal-to-noise ratios of the output voice frame corresponding to the remote voice frame on the respective key frequency bands of the remote voice frame comprises:
determining human average loudness perception correction factors corresponding to the respective key frequency bands of the remote voice frame, based on loudness of the remote voice frame and the noise frame on the respective key frequency bands of the remote voice frame, and the human auditory equal loudness contour corresponding to the current system volume of the terminal device, wherein a human average loudness perception correction factor of a target key frequency band in the respective key frequency bands of the remote voice frame is used for correcting a loudness of the target key frequency band, to adjust a signal-to-noise ratio of the target key frequency band;
determining, based on the human average loudness perception correction factors corresponding to the respective key frequency bands of the remote voice frame and preset reference signal-to-noise ratios, respective corrected signal-to-noise ratios of the respective key frequency bands of the remote voice frame to obtain the expected signal-to-noise ratios of the output voice frame corresponding to the remote voice frame on the respective key frequency bands of the remote voice frame, wherein reference signal-to-noise ratios of the respective key frequency bands of the remote voice frame are identical.

6. The method of claim 5, wherein
determining, based on the loudness of the remote voice frame and the noise frame on the respective key frequency bands of the remote voice frame and the human auditory equal loudness contour corresponding to the current system volume of the terminal device, the human average loudness perception correction factors corresponding to the respective key frequency bands of the remote voice frame comprises:
determining, based on the loudness of the remote voice frame and the noise frame in the respective key frequency bands of the remote voice frame and the human auditory equal loudness contour corresponding to the current system volume of the terminal device, actually perceived loudness and an average actually perceived loudness of the respective key frequency bands of the remote voice frame;
determining, based on the actually perceived loudness and the average actually perceived loudness of the respective key frequency bands of the remote voice frame, the respective human average loudness perception correction factors of the plurality of key frequency bands of the remote voice frame.

7. The method of claim 1, wherein
the ambient noise scene is configured by default, and a noise audio corresponding to the ambient noise scene is pre-stored.

8. The method of claim 1, wherein prior to determining, based on the voice spectrum estimation result of the remote voice frame and the noise spectrum estimation result of the noise frame corresponding to the ambient noise scene, the filter coefficient of the filter, the method further comprises:
displaying a selection interface comprising a plurality of candidate ambient noise scenes, one of the candidate ambient noise scenes corresponding to a pre-stored noise audio clip;
determining a selected candidate ambient noise scene as the ambient noise scene.

9. The method of claim 1, wherein prior to determining, based on the voice spectrum estimation result of the remote voice frame and the noise spectrum estimation result of the noise frame corresponding to the ambient noise scene, the filter coefficient of the filter, the method further comprises:
receiving a scene recording operation performed by a user of the terminal device;
recording an audio of an environment where the terminal device is currently located, using an audio acquisition device of the terminal device;
creating, based on the recorded audio, a new scene, and using the same as the ambient noise scene.

10. The method of claim 1, wherein determining, based on the plurality of output voice frames cached in the terminal device, the remote voice frame, and the preset loudness corresponding to the current system volume of the terminal device, the expected loudness of the output voice frame corresponding to the remote voice frame comprises:
obtaining the preset loudness corresponding to the current system volume of the terminal device;
obtaining loudness of the plurality of output voice frames cached in the terminal device;
determining, based on the loudness of the plurality of output voice frames cached in the terminal device and the preset loudness corresponding to the current system volume of the terminal device, the expected loudness of the output voice frame corresponding to the remote voice frame, wherein, in response to the loudness of the output voice frame corresponding to the remote loudness frame being valued to the expected loudness, an average loudness of the output voice frame corresponding to the remote voice frame and the plurality of voice frames cached in the terminal device is equal to the preset loudness corresponding to the current system volume of the terminal device.

11. The method of claim 1, further comprising: storing, according to a First-In First-Out strategy, the output voice frame corresponding to the remote voice frame in a cache of the terminal device.

12. (canceled)

13. An electronic device, comprising:
a processor; and
a memory for storing computer executable instructions that, when executed, cause the processor to perform operations of a method for processing voice comprising:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively;
determining, based on the expected loudness and the filtered voice frame, an output voice frame corresponding to the remote voice frame.

14. (canceled)

15. The electronic device of claim 13, wherein the voice spectrum estimation result comprises a key frequency band distribution of the remote voice frame, the noise spectrum estimation result comprises a key frequency band distribution of the noise frame, and determining, based on the voice spectrum estimation result of the remote voice frame and the noise spectrum estimation result of the noise frame corresponding to the ambient noise scene, the filter coefficient of the filter comprises:
obtaining, based on the key frequency band distribution of the remote voice frame and the key frequency band distribution of the noise frame, current signal-to-noise ratios of respective key frequency bands in the remote voice frame;
determining, based on the current signal-to-noise ratios of the respective key frequency bands of the remote voice frame and expected signal-to-noise ratios of the output voice frame corresponding to the remote voice frame on the respective key frequency bands of the remote voice frame, the filter coefficient of the filter.

16. The electronic device of claim 15, wherein
obtaining, based on the key frequency band distribution of the remote voice frame and the key frequency band distribution of the noise frame, the current signal-to-noise ratios of the respective key frequency bands of the remote voice frame comprises:
determining, based on the key frequency band distribution of the remote voice frame, energies corresponding to the respective frequency bands of the remote voice frame;
determining, based on the key frequency band distribution of the noise frame, energies corresponding to the respective key frequency bands of the noise frame;
determining, based on the energies corresponding to the respective key frequency bands of the remote voice frame and the energies corresponding to the respective key frequency bands of the noise frame, the current signal-to-noise ratios of the respective key frequency bands of the remote voice frame.

17. The electronic device of claim 15, wherein prior to determining, based on the current signal-to-noise ratios of the respective key frequency bands in the spectrum distribution of the remote voice frame and the expected signal-to-noise ratios of the output voice frame corresponding to the remote voice frame on the respective key frequency bands in the spectrum distribution of the remote voice frame, the filter coefficient of the filter, the method further comprises:
determining, based on a human auditory equal loudness contour, the energies of the respective key frequency bands of the remote voice frame, and the energies of the respective key frequency bands of the noise frame, the expected signal-to-noise ratios of the output voice frame corresponding to the remote voice frame on the respective key frequency bands of the remote voice frame.

18. The electronic device of claim 17, wherein determining, based on the human auditory equal loudness contour, the energies of the respective key frequency bands of the remote voice frame, and the energies of the respective key frequency bands of the noise frame, the expected signal-to-noise ratios of the output voice frame corresponding to the remote voice frame on the respective key frequency bands of the remote voice frame comprises:
determining human average loudness perception correction factors corresponding to the respective key frequency bands of the remote voice frame, based on loudness of the remote voice frame and the noise frame on the respective key frequency bands of the remote voice frame, and the human auditory equal loudness contour corresponding to the current system volume of the terminal device, wherein a human average loudness perception correction factor of a target key frequency band in the respective key frequency bands of the remote voice frame is used for correcting a loudness of the target key frequency band, to adjust a signal-to-noise ratio of the target key frequency band;
determining, based on the human average loudness perception correction factors corresponding to the respective key frequency bands of the remote voice frame and preset reference signal-to-noise ratios, respective corrected signal-to-noise ratios of the respective key frequency bands of the remote voice frame to obtain the expected signal-to-noise ratios of the output voice frame corresponding to the remote voice frame on the respective key frequency bands of the remote voice frame, wherein reference signal-to-noise ratios of the respective key frequency bands of the remote voice frame are identical.

19. The electronic device of claim 18, wherein
determining, based on the loudness of the remote voice frame and the noise frame on the respective key frequency bands of the remote voice frame and the human auditory equal loudness contour corresponding to the current system volume of the terminal device, the human average loudness perception correction factors corresponding to the respective key frequency bands of the remote voice frame comprises:
determining, based on the loudness of the remote voice frame and the noise frame in the respective key frequency bands of the remote voice frame and the human auditory equal loudness contour corresponding to the current system volume of the terminal device, actually perceived loudness and an average actually perceived loudness of the respective key frequency bands of the remote voice frame;
determining, based on the actually perceived loudness and the average actually perceived loudness of the respective key frequency bands of the remote voice frame, the respective human average loudness perception correction factors of the plurality of key frequency bands of the remote voice frame.

20. The electronic device of claim 13, wherein
the ambient noise scene is configured by default, and a noise audio corresponding to the ambient noise scene is pre-stored.

21. The electronic device of claim 13, wherein prior to determining, based on the voice spectrum estimation result of the remote voice frame and the noise spectrum estimation result of the noise frame corresponding to the ambient noise scene, the filter coefficient of the filter, the method further comprises:
displaying a selection interface comprising a plurality of candidate ambient noise scenes, one of the candidate ambient noise scenes corresponding to a pre-stored noise audio clip;
determining a selected candidate ambient noise scene as the ambient noise scene.

22. A non-transitory computer readable storage medium having computer executable instructions stored thereon, wherein the computer executable instructions, when executed by a processor, implement operations of a method for processing voice comprising:
receiving a remote voice frame;
determining, based on a voice spectrum estimation result of the remote voice frame and a noise spectrum estimation result of a noise frame corresponding to an ambient noise scene, a filter coefficient of a filter;
filtering the remote voice frame using the filter having the filter coefficient to obtain a filtered voice frame;
determining, based on a plurality of output voice frames cached in the terminal device, the remote voice frame, and a preset loudness corresponding to a current system volume of the terminal device, an expected loudness of an output voice frame corresponding to the remote voice frame, wherein the plurality of output voice frames cached in the terminal device comprises output voice frames corresponding to a plurality of received voice frames close to the remote voice frame in time sequence respectively;
determining, based on the expected loudness and the filtered voice frame, an output voice frame corresponding to the remote voice frame.
